(19) United States
(12) Patent Application Publication
(10) Pub. No.: US 2026/0204761 A1
(43) Pub. Date: Jul. 16, 2026

(54) Stepped Impedance Quasi-Optical THZ Filters Using Metamaterial Dielectric Layers

(71) Applicant: Arizona Board of Regents on behalf of Arizona State University, Scottsdale, AZ (US)

(72) Inventors: Philip Mauskopf, Scottsdale, AZ (US); Adhitya Sriram, Tempe, AZ (US)

(21) Appl. No.: 19/131,381

(22) PCT Filed: Nov. 30, 2023
(86) PCT No.: PCT/US2023/081852

§ 371 Date: May 20, 2025

Related U.S. Application Data
(60) Provisional application No. 63/385,713, filed on Dec. 1, 2022.

(51) Int. Cl. H01P 1/201; H01P 11/00

(52) U.S. Cl. CPC H01P 1/201; H01P 11/007

(57) ABSTRACT

A multimode free-space coupled filter and a method of forming the filter are disclosed. The filter includes a first layer comprising a dielectric film; a second layer disposed on the first layer, the second layer comprising a dielectric film with a regularly spaced pattern of metal features, wherein the metal features are uniform in size and spacing with a period g and spacing between the features given by 2a, one or more additional first and one or more additional second layers, wherein the one or more additional first layers and the one or more additional second layers are disposed to alternate; and a topmost layer comprising a dielectric film disposed on a top surface of a topmost layer comprising a dielectric film with a regularly spaced pattern of metal features.

### CROSS REFERENCE TO RELATED APPLICATIONS

This application claims priority under 35 U.S.C. § 119 to U.S. Provisional Patent Application No. 63/385,713 filed Dec. 1, 2022, the contents of which are hereby incorporated by reference in its entirety.

### FIELD

This application is directed to high frequency filters, and in particular, to stepped impedance quasi-optical THz filters using metamaterial dielectric layers and method for forming thereof.

### BACKGROUND

Microwave filters are used in a wide range of applications and can take the forms including lumped element filters, planar distributed filters, and quasi-optical filters. Lumped element filters generally are used at low frequencies and consist of networks of chip capacitors, inductors and resistors where the dimensions of the chips are very small compared to the effective wavelength of the signal in the circuit. Planar distributed filters such as microstrip filters consist of patterned two-dimensional transmission line structures on a dielectric substrate with sizes comparable to a wavelength. Quasi-optical filters are elements that act on electromagnetic waves propagating in free space and are used in a variety of applications including communications, radar and astronomical instruments. Many of the filters used in astronomical ground-based and space-based instruments at mm-wave to THz frequencies are designed and fabricated by a combination of Cardiff University and QCM Instruments, Ltd. in the UK. These filters historically consisted of individual thin plastic (e.g., mylar or polypropylene) layers with a thin layer of copper deposited on the plastic membrane and then patterned to form a metal mesh structure representing a frequency dependent shunt impedance. These individual layers were then separated by vacuum or transparent plastic spacers with thicknesses, d, close to one quarter of the filter cutoff or cuton wavelength. Low pass or high pass filters can be modeled as a sequence of inductors and capacitors. The design of the Cardiff quasi optical filters therefore typically used either capacitive or inductive grids (or a resonant combination). The capacitive grids consist of a pattern of square metal pads with a typical grid spacing, g and separation between square pads, 2a. The inductive grids are the inverse pattern consisting of a square grid of wires with width 2a and grid spacing, g and the combined grids have both patterns superimposed with different values of the gap, a. Note that both the typical grid spacing, g and separation between metallized layers, d for these filters are large enough that these designs do not qualify as “bulk metamaterials”.

### SUMMARY

According to examples of the present disclosure, a multimode free-space coupled filter is disclosed. The filter comprises a first layer comprising a dielectric film; a second layer disposed on the first layer, the second layer comprising a dielectric film with a regularly spaced pattern of metal features, wherein the metal features are uniform in size and spacing with a period g and spacing between the features given by 2a, one or more additional first and one or more additional second layers, wherein the one or more additional first layers and the one or more additional second layers are disposed to alternate; and a topmost layer comprising a dielectric film disposed on a top surface of a topmost layer comprising a dielectric film with a regularly spaced pattern of metal features.

Various additional features can be included in the filter including one or more of the following features. The second layer has an effective impedance given by Xc/Z=1/n² [4 g/λ In (cosec (πa/g)]⁻¹, where Xc is an impedance of a single layer, n is the index of refraction of a dielectric substrate, λ is a wavelength of an incidence electromagnetic wave, and Z is the impedance of free space. The first layer and the second layer have an effective impedance given by Z_{eff}=√(μ₀/(ε₀ εᵣ+ (C_{grid}/d))) where Z_{eff} is the effective impedance, μ₀ and ε₀ are the permeability and permittivity of free space and εᵣ is the relative permittivity of the substrate. The dielectric film comprises a low-loss dielectric material. The dielectric film comprises polypropylene, polyimide, or cyclic-olefin copolymer. The metal features are periodic arrays of metal squares or rectangles. The metal features comprise aluminum, copper, gold, or silver. The filters can be designed as high pass, low pass and band pass filters for frequencies up to 1 THz.

According to examples of the present disclosure, a method of forming a multimode free-space coupled filter is disclosed. The method comprises providing a first dielectric film; forming a first dielectric film and a dielectric film with a regularly spaced pattern of metal features by photolithography over the second dielectric film, wherein the metal features are uniform in size and spacing with a period g and spacing between the features given by 2a; providing a second dielectric film over the first dielectric film and the dielectric film with the regularly spaced pattern of metal features; and providing a topmost layer comprising a dielectric film disposed on a top surface of a topmost layer comprising a dielectric film with a regularly spaced pattern of metal features.

Various additional features can be included in the method including one or more of the following features. The second layer has an effective impedance given by Xc/Z=1/n² [4 g/λ In (cosec (πa/g)]⁻¹, where Xc is an impedance of a single layer, n is the index of refraction of a dielectric substrate, λ is a wavelength of an incidence electromagnetic wave, and Z is the impedance of free space. The first layer and the second layer have an effective impedance given by Z_{eff}=√(μ₀/(ε₀ εᵣ+ (C_{grid}/d))) where Z_{eff} is the effective impedance, μ₀ and ε₀ are the permeability and permittivity of free space and εᵣ is the relative permittivity of the substrate. The dielectric film comprises a low-loss dielectric material. The dielectric film comprises polypropylene, polyimide, or cyclic-olefin copolymer. The metal features are periodic arrays of metal squares or rectangles. The metal features comprise aluminum, copper, gold, or silver. The filters can be designed as high pass, low pass and band pass filters for frequencies up to 1 THz.

According to examples of the present disclosure, a multimode free-space coupled filter is disclosed. The filter comprises a first layer comprising a dielectric film; alternating layers of a dielectric film and a dielectric film with a regularly spaced pattern of metal features disposed on a top surface of the first layer, wherein the metal features are uniform in size and spacing with a period g and spacing between the features given by 2a; and a topmost layer comprising a dielectric film disposed on a top surface of a topmost layer comprising a dielectric film with a regularly spaced pattern of metal features. Various additional features can be included in the filter including one or more of the following features. The second layer has an effective impedance given by Xc/Z=1/n² [4 g/λ In (cosec (πa/g)]⁻¹, where Xc is an impedance of a single layer, n is the index of refraction of a dielectric substrate, λ is a wavelength of an incidence electromagnetic wave, and Z is the impedance of free space. The first layer and the second layer have an effective impedance given by Z_{eff}=√(μ₀/(ε₀ εᵣ+ (C_{grid}/d))) where Z_{eff} is the effective impedance, μ₀ and ε₀ are the permeability and permittivity of free space and εᵣ is the relative permittivity of the substrate. The dielectric film comprises a low-loss dielectric material. The dielectric film comprises polypropylene, polyimide, or cyclic-olefin copolymer. The metal features are periodic arrays of metal squares or rectangles. The metal features comprise aluminum, copper, gold, or silver. The filters can be designed as high pass, low pass and band pass filters for frequencies up to 1 THz.

### BRIEF DESCRIPTION OF THE FIGURES

FIG. 1A shows a cross-sectional side view of a stepped impedance quasi-optical THz filter according to examples of the present disclosure.

FIG. 1B shows a more detailed view of a portion of the cross-sectional side view of the stepped impedance quasi-optical THz filter according to examples of the present disclosure.

FIG. 2A shows a side perspective view of the stepped impedance quasi-optical THz filter of FIG. 1A.

FIG. 2B shows a top view of one layer of dielectric film layer with a regularly spaced pattern of metal features of FIG. 2A.

FIG. 3A shows a side perspective view of another example of the stepped impedance quasi-optical THz filter according to examples of the present disclosure.

FIG. 3B shows a top view of one layer of dielectric film layer with a regularly spaced pattern of metal features of FIG. 3A.

FIG. 4A shows a top view 400 of one layer of dielectric film layer with a regularly spaced pattern of metal features of FIG. 3A and FIG. 3B in more detail.

FIG. 4B shows a close-up of a region of FIG. 4A showing four metal features arranged as squares.

FIG. 5A shows a top view of one layer of dielectric film layer with a regularly spaced pattern of metal features of FIG. 2A and FIG. 2B in more detail.

FIG. 5B shows a close-up of a region of FIG. 5A showing four metal features arranged as squares.

FIG. 6A shows another example of a top view of one layer of dielectric film layer with a regularly spaced pattern according to examples of the present disclosure.

FIG. 6B shows a close-up of a region of FIG. 6A.

FIG. 6C shows a perspective side view of the filter of FIG. 6A.

FIG. 7 shows filter simulation results according to examples of the present disclosure.

FIG. 8 shows polyimide reflection resonance results according to examples of the present disclosure.

### DETAILED DESCRIPTION

Generally speaking, examples of the present disclosure describe filters and methods to fabricate filters that function to filter radiation in a way that is similar to multilayer optical dielectric filters and provide filtering of long wavelengths (>300 microns) in free space. At long wavelengths, the disclosed method allows for the creation of custom dielectric materials by embedding periodic metallic grids in a dielectric substrate. This allows highly efficient and low loss filters to be made, which are typically used in long wavelength astronomical instruments and high frequency communications. According to examples, the filter can use a quasi-optical (multimode, coupled to free space) multilayer dielectric (stepped impedance) filter at long wavelengths made from artificial dielectric materials.

Quasi-optical metal mesh filters realized using equivalent capacitive and inductive grids have been used for free space millimeter-wave to far-IR (THz) filtering applications. Examples of these filters are low pass filters using free space capacitive shunts which are realized as arrays of square metal grids. Another example in microstrip are resonant stubs separated by λ/4. Disadvantages of these filters are that the grids are not ideal capacitors because they exhibit diffraction approximately 2× above their resonant frequency and therefore have high frequency leaks. Other types of filters that are commonly used in microstrip form are stepped impedance filters and elliptic filters. Both of these can be realized in quasi-optical metal mesh using artificial dielectrics. Stepped impedance filters are the most common type of filter for optical wavelengths which are manufactured using multilayer dielectric films. Examples of the present disclosure provide for an improved design for free-space coupled quasi optical filters based on stepped impedance designs where the dielectric layers are realized as metamaterials using metal mesh patterns.

Broad-band artificial dielectric quasi-optical metamaterials for mm-wave and THz applications comprise capacitive grids with grid spacing much smaller than the wavelength of interest and separation between layers also small compared to the wavelengths of interest. This design allowed the production of artificial dielectric materials by stacking patterned metal mesh layers on thin plastic substrates where the dielectric constant depends on the grid spacing, g, the gap between square pads, 2a, and the separation between the metallic layers, d. This allows for the design of novel wave plates, antireflection coatings and flat gradient index lenses, and in particular, to the design of new types of quasi-optical filters based on artificial quasi-optical dielectrics arranged as a stepped impedance filter.

According to examples of the present disclosure, a multimode free-space coupled filter structure is disclosed as a series of high and low impedance sections where the impedances are manufactured from artificial dielectric metamaterials. An individual filter can be designed by optimizing a schematic design using a transmission line model for the high and low impedance sections and coupling the input and output ports to free space or approximately 377 Ohms. Designs for these stepped impedance filters are commonly used for filters in planar transmission line circuits at high frequencies. The artificial dielectric layers are comprised of patterned metal square arrays on dielectric substates separated by dielectric spacers. The metal squares are uniform in size and spacing with a period, g, and spacing between squares given of 2a. The effective impedance of a single layer of such a grid is given by: Xc/Z=1/n\hat{ }2 [4 g/λ ln(cosec(πa/g))]\hat{ }(−1) where Xc is the impedance of a single layer, n is the index of refraction of the dielectric substrate, λ is the wavelength of an incident electromagnetic wave and Z is the impedance of free space. To create an artificial dielectric layer with a given impedance and thickness, multiple individual grids are stacked together, separated by a distance, d.

The effective value of the impedance of the artificial dielectric layer is approximately given by: Z_eff=√(μ₀/(ε₀ εᵣ+ (C_grid/d))) where Z_eff is the effective impedance, μ₀ and ε₀ are the permeability and permittivity of free space and εᵣ is the relative permittivity of the substrate. The impedance values in the filter itself are constrained to be between the intrinsic impedance of the substrate material (i.e. Z_{substrate}=Z₀/n_substrate) and approximately 1/10 of that value depending on constraints in fabricating the metal grids as well as limits to the decrease in the effective impedance as the separation between layers becomes small.

Once a filter has been designed and simulated schematically using transmission line theory, the above formulas are used to estimate the dimensions of the patterned metal layers and separation between the layers and number of layers per impedance section given a particular substrate. Example substrates include polypropylene, polyimide, or cyclic-olefin copolymer. The lower the index of refraction of the substrate the easier it is to match the filter to free space. Grid designs are then simulated using a 3D electromagnetic design solver such as Ansoft HFSS and the S-parameters are used to optimize the design in the schematic model. Once the design is fixed, the filter can be fabricated by depositing metal (usually copper) onto a thin dielectric substrate, patterning the metal layer and etching the pattern using standard photolithography and then either depositing a dielectric spacing layer using spin coating and then repeating the process until all the layers are completed or fabricating each metal pattern separately on a thin dielectric substrate and stacking them either with vacuum spacers or with the dielectric spacers using a hot press technique or a thin layer of glue with a low dielectric loss to form the filter.

Most optical filters for laboratory use or use in cameras are made from multiple coatings of different dielectric materials where the difference in the index of refraction of the materials causes multiple internal reflections and the thicknesses of the layers are carefully designed to transmit the desired colors of light. In contrast, at radio wavelengths, filters are typically designed using either lumped element capacitors, inductors and resistors or they are designed as patterned planar structures on a chip or circuit board. These long wavelength filters require a way of collecting radio waves traveling through the air, such as an antenna onto the circuit board or chip. According to examples of the present disclosure, filters at long wavelengths can be made that work in a way that is similar to multilayer optical dielectric filters and provide filtering of long wavelengths in free space. At long wavelengths, the disclosed custom dielectric materials can be made by embedding periodic metallic grids in a dielectric substrate. This allows highly efficient and low loss filters which are typically used in long wavelength astronomical instruments and high frequency communications.

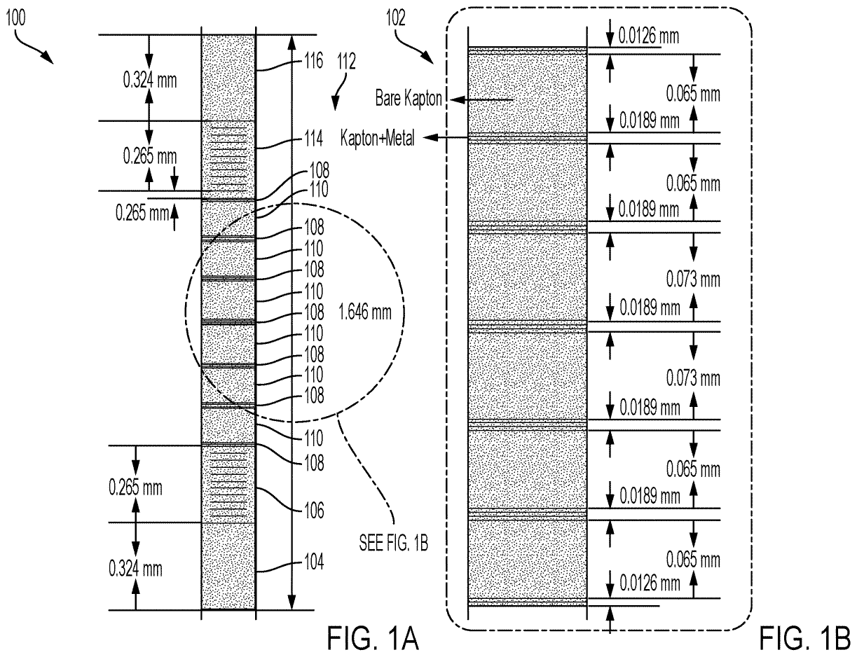

FIG. 1A shows cross-sectional side view 100 of a stepped impedance quasi-optical THz filter according to examples of the present disclosure. FIG. 1B shows a more detailed view 102 of a portion of cross-sectional side view 100 of the stepped impedance quasi-optical THz filter according to examples of the present disclosure. The stepped impedance quasi-optical THz filter comprises alternating layers of a dielectric film and a dielectric film with a regularly spaced pattern of metal features. The number of alternating layers and the dimensions shown in FIG. 1A and FIG. 1B are merely one non-limiting example and can be varied depending on the application for which the filter is used, the manufacturing process used to make the filter, and/or a cutoff frequency produced by the filter. The stepped impedance quasi-optical THz filter comprises first dielectric film layer 104 and first dielectric film layer with a regularly spaced pattern of metal features 106. First dielectric film layer with a regularly spaced pattern of metal features 106 is formed on a top surface of first dielectric film layer 104. Middle section 112, which is shown enlarged in FIG. 1B, comprises alternating layers of a dielectric film 110 and dielectric film with a regularly spaced pattern of metal features 108. Second dielectric film layer 116 and second dielectric film layer with a regularly spaced pattern of metal features 114 are formed over a top surface of the topmost layer of middle section 112.

As shown in FIG. 1A and FIG. 1B, the total thickness of the stepped impedance quasi-optical THz filter is about 1.646 mm±0.25 mm. First dielectric film layer 104 and second dielectric film layer 116 have a thickness of about 0.324 mm±0.05 mm. First dielectric film layer with a regularly spaced pattern of metal features 106 and second dielectric film layer with a regularly spaced pattern of metal features 114 have a thickness of about 0.265 mm±0.05 mm. Alternating layers of a dielectric film 110 have a thickness of about 0.073 mm±0.005 mm and dielectric film with a regularly spaced pattern of metal features 108 have a thickness of about 0.0189 mm+0.005 mm.

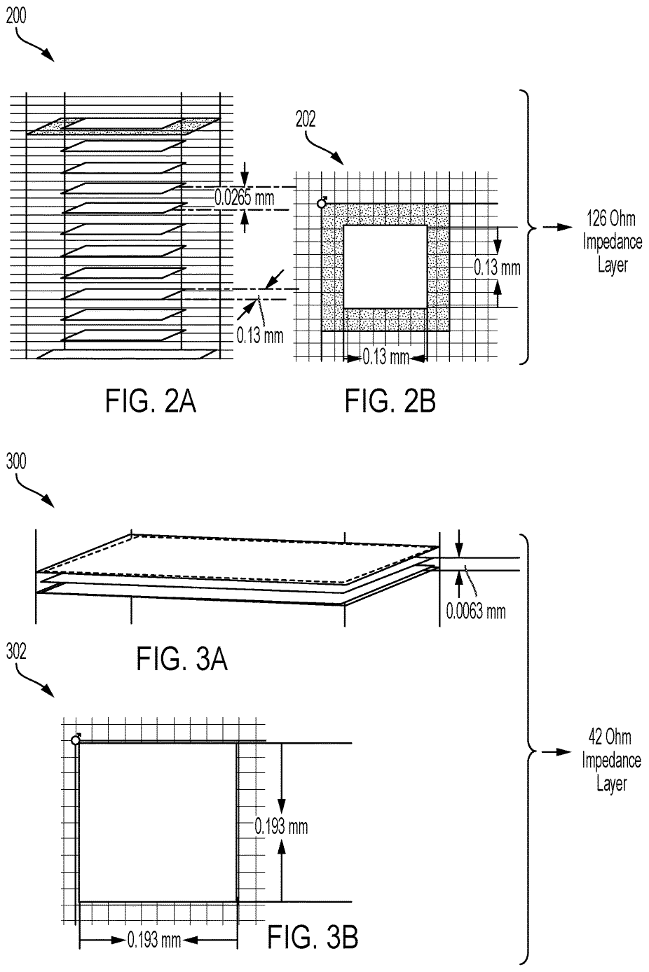

FIG. 2A shows a side perspective view 200 of the stepped impedance quasi-optical THz filter of FIG. 1A. FIG. 2B shows a top view 202 of one layer of dielectric film layer with a regularly spaced pattern of metal features of FIG. 2A. The metal feature is shown as a square with a width of about 0.13 mm±0.03 mm. The separation distance between the layers of dielectric film layer with a regularly spaced pattern of metal features is shown to be about 0.0265 mm±0.005 mm. The metal feature can comprise gold, silver, or copper. The layer shown in FIG. 2B has an impedance of 126 Ohm. However, this is just one non-limiting example of the shape of the metal feature. Other shapes may be used depending on the application for which the filter is used, the manufacturing process used to make the filter, and/or a cutoff frequency produced by the filter.

FIG. 3A shows a side perspective view 300 of another example of the stepped impedance quasi-optical THz filter. FIG. 3B shows a top view 302 of one layer of dielectric film layer with a regularly spaced pattern of metal features of FIG. 3A. The metal feature is shown as a square with a width of about 0.193 mm±0.005 mm. The separation distance between the layers of dielectric film layer with a regularly spaced pattern of metal features is shown to be about 0.0063 mm±0.005 mm. The metal feature can comprise gold, silver, or copper. The layer shown in FIG. 3B has an impedance of 42 Ohm. However, this is just one non-limiting example of the shape of the metal feature. Other shapes may be used depending on the application for which the filter is used, the manufacturing process used to make the filter, and/or a cutoff frequency produced by the filter.

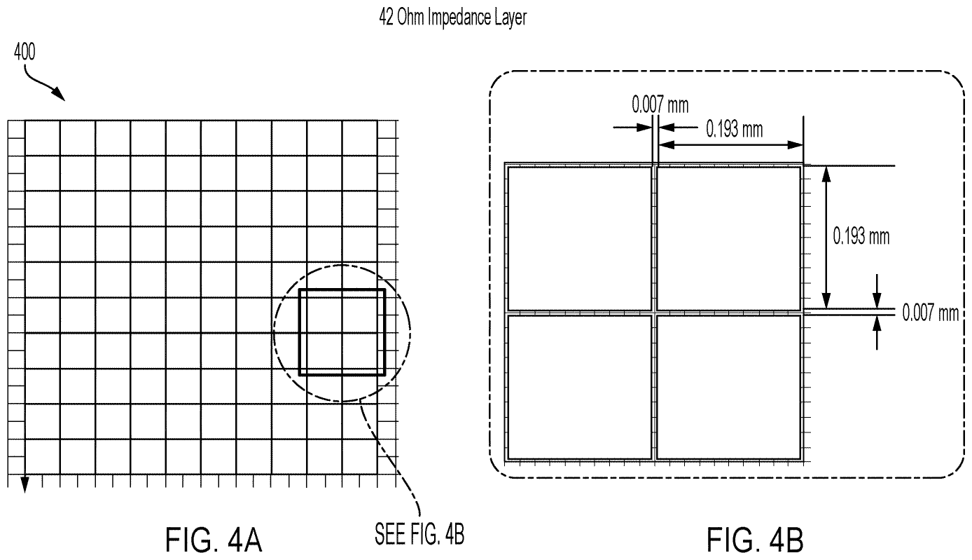

FIG. 4A shows a top view 400 of one layer of dielectric film layer with a regularly spaced pattern of metal features of FIG. 3A and FIG. 3B in more detail. FIG. 4B shows a close-up of a region of FIG. 4A showing four metal features arranged as squares. As shown in FIG. 4B, each square of metal has a width of 0.193 mm±0.005 mm and each square is spaced apart from an adjacent square by 0.007 mm±0.002 mm.

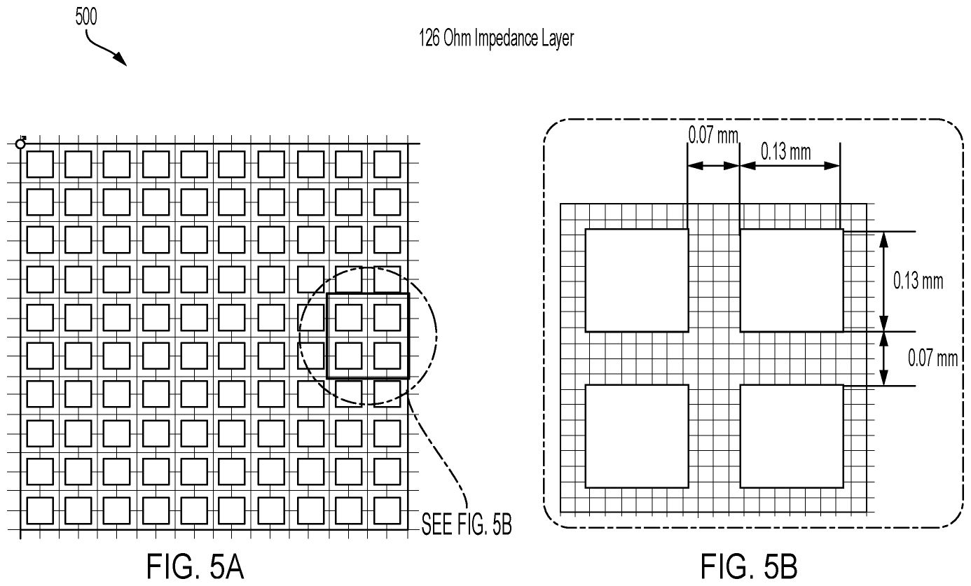

FIG. 5A shows a top view 500 of one layer of dielectric film layer with a regularly spaced pattern of metal features of FIG. 2A and FIG. 2B in more detail. FIG. 5B shows a close-up of a region of FIG. 5A showing four metal features arranged as squares. As shown in FIG. 5B, each square of metal has a width of 0.13 mm±0.01 mm and each square is spaced apart from an adjacent square by 0.07 mm±0.02 mm.

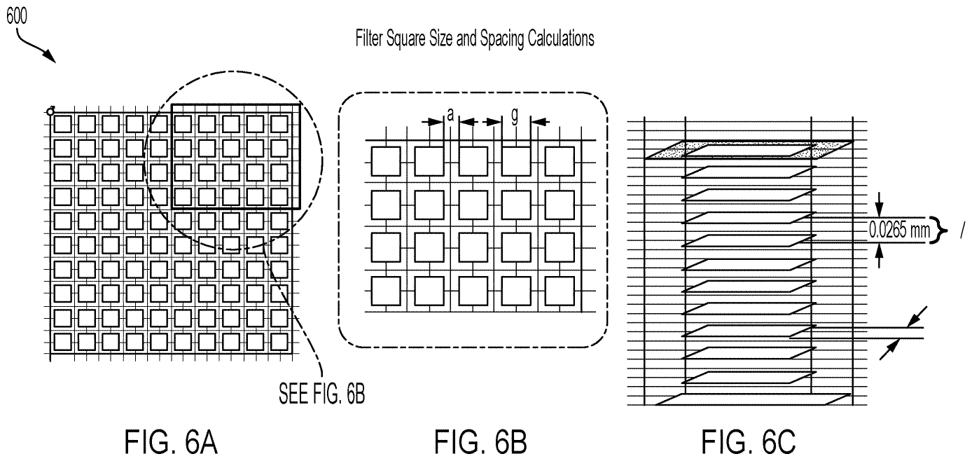

FIG. 6A shows another example of a top view 600 of one layer of dielectric film layer with a regularly spaced pattern. FIG. 6B shows a close-up of a region of FIG. 6A. FIG. 6C shows a perspective side view of the filter. In particular, FIG. 6B and FIG. 6C show example square sizes and spacing used in the equations below according to examples of the present disclosure.

The impedance of an array of square metal grids can be calculated as follows:

$$\frac{{X}_{c}}{Z} = {\frac{1}{{n}^{2}} [ \frac{4 g}{λ} ln ( cosec ( \frac{π a}{g} ) ) ]}^{- 1}$$

where n is the refractive index of the artificial dielectric material, a is the gap between two adjacent metal grids and g is the period of the adjacent metal grids. The impedance of capacitive metal grid is completely described by the refractive index, geometrical ratio (a/g) and the wavelength of interest. The effective impedance of the grid can be calculated as follows:

$${Z}_{eff} = \sqrt{\frac{{μ}_{0}}{{ε}_{0} {ε}_{r} + ( \frac{{C}_{grid}}{l} )}}$$

where l is the vertical spacing between the metal squares on subsequent layers.

Thus, a free-space quasi-optic stepped impedance filter can be designed with sections of stepped effective impedance and each of these sections can be modeled using ideal transmission lines having an equivalent impedance and an equivalent electrical length.

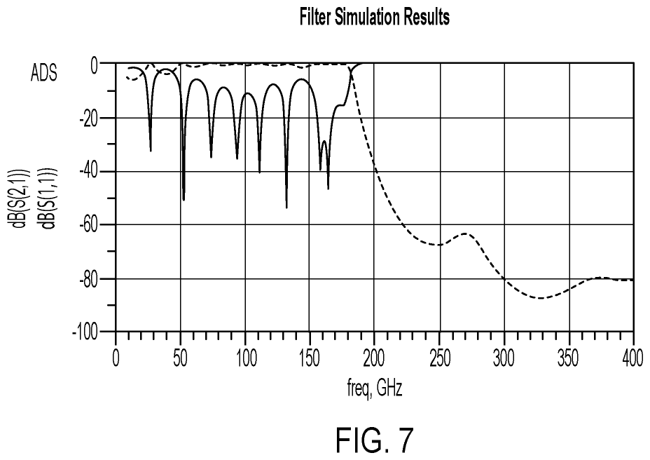

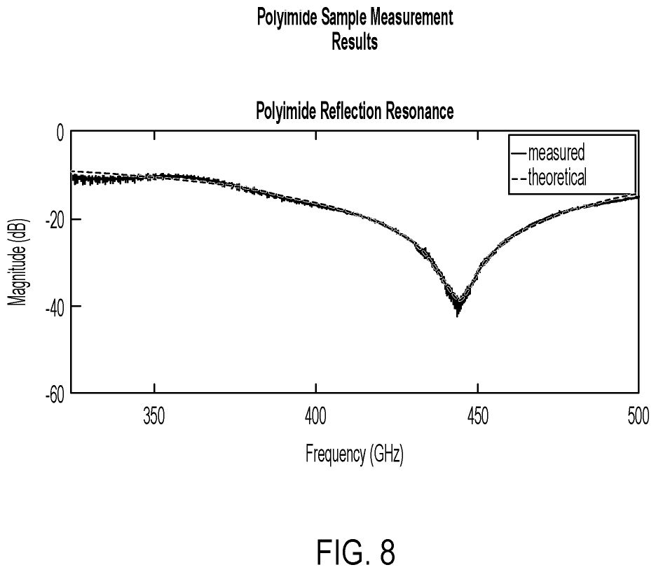

FIG. 7 shows filter simulation results according to examples of the present disclosure. FIG. 8 shows polyimide reflection resonance results according to examples of the present disclosure.

In summary, examples of the present disclosure provide for use of a quasi-optical (multimode, coupled to free space) multilayer dielectric (stepped impedance) filter at long wavelengths where the filter makes use of artificial dielectric materials. The advantages over current technology include the use of stepped impedance filters for microwaves or millimeter waves is currently limited to single mode designs coupled to planar transmission lines and the use of artificial dielectrics (meta materials) in a multilayer dielectric filter allows for a larger range of dielectric constants which enables improved filter performance. The present disclosure provides for a free space coupled design. The present filters can be used in several areas of commercial potential for these filters including the use in long wavelength (radio to far-infrared) astronomical instruments both on ground-based and space-based telescopes and in high end radio and millimeter-wave communications downlink receivers.

Those skilled in the art will recognize improvements and modifications to the preferred embodiments of the present disclosure. All such improvements and modifications are considered within the scope of the concepts disclosed herein and the claims that follow. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

The various embodiments are described for illustrative purposes only with reference to the Figures. Those of skill in the art will appreciate that the following description is exemplary in nature, and that various modifications to the parameters set forth herein could be made without departing from the scope of the present embodiments. It is intended that the specification and examples be considered as examples only. The various embodiments are not necessarily mutually exclusive, as some embodiments can be combined with one or more other embodiments to form new embodiments.

While the embodiments have been illustrated respect to one or more implementations, alterations and/or modifications can be made to the illustrated examples without departing from the spirit and scope of the appended claims. In addition, while a particular feature of the embodiments may have been disclosed with respect to only one of several implementations, such feature may be combined with one or more other features of the other implementations as may be desired and advantageous for any given or particular function.

Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of A, B and C.

Other embodiments will be apparent to those skilled in the art from consideration of the specification and practice of the descriptions disclosed herein. It is intended that the specification and examples be considered as exemplary only, with a true scope and spirit of the embodiments being indicated by the following claims.

What is claimed is:

1. A multimode free-space coupled filter, the filter comprising:
a first layer comprising a dielectric film;
a second layer disposed on the first layer, the second layer comprising a dielectric film with a regularly spaced pattern of metal features, wherein the metal features are uniform in size and spacing with a period g and spacing between the features given by 2a,
one or more additional first and one or more additional second layers, wherein the one or more additional first layers and the one or more additional second layers are disposed to alternate; and
a topmost layer comprising a dielectric film disposed on a top surface of a topmost layer comprising a dielectric film with a regularly spaced pattern of metal features.

2. The multimode free-space coupled filter of claim 1, wherein the second layer has an effective impedance given by Xc/Z=1/n² [4 g/λ In (cosec (πa/g)]⁻¹, where Xc is an impedance of a single layer, n is the index of refraction of a dielectric substrate, λ is a wavelength of an incidence electromagnetic wave, and Z is the impedance of free space.

3. The multimode free-space coupled filter of claim 1, wherein the first layer and the second layer have an effective impedance given by Z_{eff}=√(μ₀/(ε₀ εᵣ+(C_{grid}/d))) where Z_{eff} is the effective impedance, μ₀ and ε₀ are the permeability and permittivity of free space and εᵣ is the relative permittivity of the substrate and d is the spacing between metallized layers.

4. The multimode free-space coupled filter of claim 1, wherein the dielectric film comprises a low-loss dielectric material.

5. The multimode free-space coupled filter of claim 1, wherein the dielectric film comprises polypropylene, polyimide, or cyclic-olefin copolymer.

6. The multimode free-space coupled filter of claim 1, wherein the metal features are periodic arrays of metal squares or rectangles.

7. The multimode free-space coupled filter of claim 1, wherein the metal features comprise aluminum copper, gold, or silver.

8. The multimode free-space coupled filter of claim 1, wherein the filters can be designed as high pass, low pass and band pass filters for frequencies up to 1 THz.

9. A method of forming a multimode free-space coupled filter, the method comprising:
providing a first dielectric film;
forming a first dielectric film and a dielectric film with a regularly spaced pattern of metal features by photolithography over the second dielectric film, wherein the metal features are uniform in size and spacing with a period g and spacing between the features given by 2a;
providing a second dielectric film over the first dielectric film and the dielectric film with the regularly spaced pattern of metal features; and
providing a topmost layer comprising a dielectric film disposed on a top surface of a topmost layer comprising a dielectric film with a regularly spaced pattern of metal features.

10. The method of claim 9, wherein a single layer of the dielectric film with the regularly spaced pattern of metal features has an effective impedance given by Xc/Z=1/n² |4 g/λ In (cosec (πa/g)]⁻¹, where Xc is an impedance of a single layer, n is the index of refraction of a dielectric substrate, λ is a wavelength of an incidence electromagnetic wave, and Z is the impedance of free space.

11. The method of claim 9, wherein multiple layers of the alternating layers of a dielectric film and a dielectric film with a regularly spaced pattern of metal features has an effective impedance given by Z_{eff}=√(μ₀/(ε₀ εᵣ+ (C_{grid}/d))) where Z_{eff} is the effective impedance, μ₀ and ε₀ are the permeability and permittivity of free space and εᵣ is the relative permittivity of the substrate and d is the spacing between metallized layers.

12. The method of claim 9, wherein the dielectric film comprises a low-loss dielectric material.

13. The method of claim 9, wherein the dielectric film comprises polypropylene, polyimide, or cyclic-olefin copolymer.

14. The method of claim 9, wherein the metal features are periodic arrays of metal squares or rectangles.

15. The method of claim 9, wherein the metal features comprise aluminum, copper, gold, or silver.

16. A multimode free-space coupled filter, the filter comprising:
a first layer comprising a dielectric film;
alternating layers of a dielectric film and a dielectric film with a regularly spaced pattern of metal features disposed on a top surface of the first layer, wherein the metal features are uniform in size and spacing with a period g and spacing between the features given by 2a; and
a topmost layer comprising a dielectric film disposed on a top surface of a topmost layer comprising a dielectric film with a regularly spaced pattern of metal features.

17. The multimode free-space coupled filter of claim 16, wherein a single layer of the dielectric film with the regularly spaced pattern of metal features has an effective impedance given by Xc/Z=1/n² |4 g/λ In (cosec (πa/g)|⁻¹, where Xc is an impedance of a single layer, n is the index of refraction of a dielectric substrate, λ is a wavelength of an incidence electromagnetic wave, and Z is the impedance of free space.

18. The multimode free-space coupled filter of claim 16, wherein multiple layers of the alternating layers of a dielectric film and a dielectric film with a regularly spaced pattern of metal features has an effective impedance given by Z_{eff}=√(μ₀/(ε₀ ε_r+(C_{grid}/d))) where Z_{eff} is the effective impedance, μ₀ and ε₀ are the permeability and permittivity of free space and εᵣ is the relative permittivity of the substrate and d is the spacing between metallized layers.

19. The multimode free-space coupled filter of claim 16, wherein the dielectric film comprises a low-loss dielectric material.

20. The multimode free-space coupled filter of claim 16, wherein the dielectric film comprises polypropylene, polyimide, or cyclic-olefin copolymer.
